(19) United States
(12) Patent Application Publication
(10) Pub. No.: US 2008/0095293 A1
(43) Pub. Date: Apr. 24, 2008

(54) C-pinch, plasma-ring thermonuclear fusion reactors and method

(76) Inventor: James Scott Hacsi, Pueblo, CO (US)

Correspondence Address: JAMES SCOTT HACSI, 13 DARTMOUTH AVENUE, PUEBLO, CO, 81005, US

(21) Appl. No.: 11/582,041

(22) Filed: Oct. 17, 2006

(51) Int. Cl. G21B 1/00

(52) U.S. Cl. 376/107

(57) ABSTRACT

A plasma-ring generator is provided where a multitude of capacitors discharge across arc-points arranged ina circular or other configuration to cause a plasma-ring or plasma-structure with a circulating electric current to be formed.

### CROSS-REFERENCE TO RELATED APPLICATIONS

Not applicable

### STATEMENT REGARDING FEDERALLY SPONSORED RESEARCH

Not applicable

### SEQUENCE LISTING OR PROGRAM

Not applicable

### BACKGROUND OF THE INVENTION

1. Field of Invention

This invention relates to thermonuclear fusion reactors and reactions. More specifically, this invention relates to devices and methods capable of creating high temperatures and conditions adequate for starting, containing, and maintaining thermonuclear fusion reactions.

2. Description of Prior Art

It is commonly understood that the Z-pinch, or zeta pinch, is a type of plasma confinement system that uses an electrical current in the plasma to generate a magnetic field that compresses it. The name refers to the direction the electric current took as it flowed down a vertical quartz tube—the Z-axis on a normal mathematical diagram. The Z-pinch relies on Lenz's Law, where a changing magnetic field induces a current in a conductor that itself creates a magnetic field in the opposite direction. That is, if a magnet is approaching a conductor, current will be induced in the conductor that creates a field to push the magnet away. Since plasma itself is electrically conducting, an external magnetic field induces a current into the plasma, thus creating a magnetic field that acts to oppose the external field. The external magnetic field is “fixed” in position while the freely-flowing plasma is able to move, so the plasma is compressed inward away from the external magnetic field.

In early Z-pinch experiments the external field was generated in a large magnet which was fed by a large bank of capacitors, hoping to quickly pinch the plasma to fusion temperatures. Instead, the plasma quickly became unstable and broke into segments before it could be compressed to any workable level. Applying the current more quickly simply made it break up faster. It seemed the faster the plasma was squeezed, the faster it broke up! A few subsequent projects (up until the 1970's) attempted to avoid the instabilities by slowly increasing the external current, but all attempts to produce temperatures hot enough to result in nuclear fusion failed because the plasma quickly became unstable and broke up into segments before it was compressed to adequate levels. After some study, a reason for this was offered and it appeared basically impossible to avoid. Research into a new class of self-stabilizing plasma known as the reversed-field pinch became a major effort in the 1980's and 1990's. For many years though, the pinch devices were the only ones able to generate fusion reactions, even at a low rate.

An entirely new concept of the Z-pinch started in the 1980s. Instead of using an external magnet to generate the induction field, a set of very fine tungsten wires running around the fuel would be “dumped” with the current instead. The wires would quickly vaporize into plasma, which is conductive, and the current flow would then cause the plasma to pinch as in prior experiments. High-energy x-rays from the compressing metal-plasma would then compress a tiny fuel cylinder containing deuterium-tritium mix. The process essentially became an inertial confinement fusion system.

3. Objects and Advantages

It would therefore be advantageous to have devices and methods that are more effective for creating conditions sufficient to start and sustain thermonuclear fusion reactions. It would also be beneficial to use devices and methods based on a novel concept related to the Z-pinch process, but a concept that more adequately provides the conditions to start and sustain thermonuclear fusion reactions. More specifically, a new concept called the C-pinch, or circular-pinch, is contemplated by the present invention that is made to occur in new types of plasma-ring generators that create rings of plasma that are contained in a full-circle configuration. A huge advantage is gained with the plasma-ring generators by having a large electric current induced and made to flow in the plasmas at the time of their creation. The large electric current in the highly conductive plasma then generates a magnetic field that compresses it as the magnetic field interacts with an immovable container or an externally-generated magnetic field. The greatest advantage, however, of using the C-pinch concept is that a plasma-ring in a complete circular-configuration cannot expand along a single axis (as in a Z-pinch). Assuming the characteristic breaking up and segmentation of the plasma in the original Z-pinch systems is caused by highly-compressed plasma being ejected or “squirted” from the plasma-ends along the single “free” axis, then the same problem would be eliminated in a C-pinch system because plasma contained in a circular-configuration has no place to go! Simply put, as the plasma in a C-pinch machine is compressed, it essentially forms a rigid and very strong “backbone” that gets hotter and hotter, since that is all it's allowed to do!

A C-pinch capable of starting a fusion reaction is accomplished by discharging high-voltage, high-energy capacitors across numerous electrodes arranged in a special configuration inside a container full of a mixture of half-and-half amounts of deuterium and tritium gases. The unique configuration of capacitor discharge-electrodes, known as arc-points, causes the gas mixture to form plasma between the arc-points; but more importantly, a circulating and almost self-sustaining electric current is made to flow in the plasma when it is created. This eliminates the need to have an electric current induced into the highly-conductive plasma by some external means. Thus, a system based on the C-pinch concept creates compressed plasma that cannot expand along any single axis, but is instead fully-contained in a circular configuration. Moreover, the highly-compressed, highly-conductive plasma has a characteristic large electric current flowing through it (in one direction) from the instant the plasma is formed!

Accordingly, some objects and advantages of methods and devices based on the C-pinch concept are:
a. to provide devices effective at producing conditions to start, maintain, and contain thermonuclear fusion reactions;
b. to provide a method of producing unlimited quantities of electric energy;
c. to provide a source for high-energy x-rays;
d. to produce ultrahigh magnetic fields.

### SUMMARY

In accordance with the present invention, it has been shown that devices and methods are contemplated for providing the conditions to start, contain, and maintain a nuclear fusion reaction. A new C-pinch concept has been introduced for effectively generating plasma contained in a circular-configuration so that it can't expand along any axis as it is compressed and heated to extreme levels. Moreover, plasmas created with devices based on the C-pinch concept have a large electric current that begins to flow immediately at the time of plasma-formation which increases in intensity as the plasma is compressed to a high degree by electrically and magnetically interacting with a container. If a proper mixture of gases is used for forming the plasma, then temperatures will be attained by the C-pinch to cause atoms or elements of the fuel-gas mixture to fuse together and initiate a nuclear fusion reaction with a tremendous release of energy.

### DRAWING FIGURES

FIG. 1 shows a single arc-segment of a C-pinch, plasma-ring generator during the “firing” phase.

FIG. 2 shows a six-in/six-out configuration C-pinch, plasma-ring generator during the “firing” stage.

FIG. 3 shows the circular-plasma that has just been created by the “firing” of a C-pinch, plasma-ring generator being “pinched” by opposing magnetic fields. A coil or series of coils is added for “supercharging”.

### DRAWING FIGURES—REFERENCE NUMERALS

1. high-voltage, high-energy capacitor
2. container
3. switch
4. arc-point or discharge-electrode
5. gas mixture
6. tungsten wire coil, coils, or wire filaments
7. high-voltage power supply

### DETAILED DESCRIPTON OF THE DRAWING FIGURES

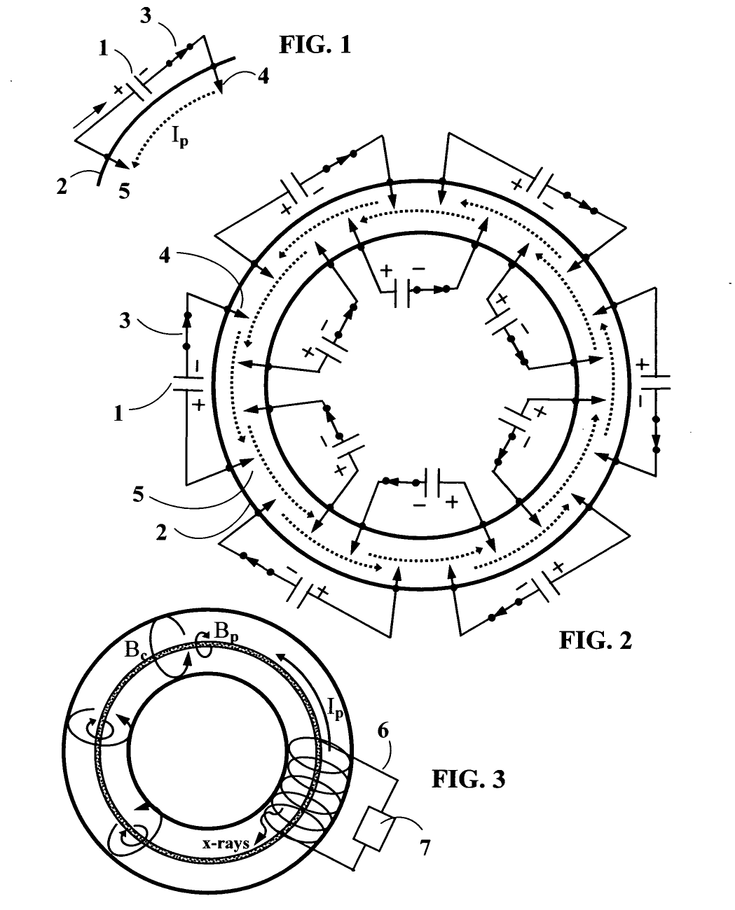

In FIG. 1, the basic components of a single arc-segment are shown which include a capacitor 1 with a high value of capacitance that has been previously energized to a very high voltage by an energizing means, a switch 3 for connecting the capacitor plates to the arc-points 4, a container 2 that contains the arc-points and a gas mixture 5 inside the container 2.

In FIG. 2, a preferred embodiment of this invention is shown, which is a device known as a C-pinch, plasma-ring generator with six inside arc-segments and six outside arc-segments. The generator is shown in the “firing” stage.

In FIG. 3, a “pinched”-plasma in the container of a C-pinch, plasma-ring generator is shown with a tungsten wire coil added for “supercharging”.

### Operation

In FIG. 1, when the switch 3 is closed, a circuit is completed and the previously energized high-voltage capacitor 1 de-energizes through the arc-points 4 located inside the container 2 that is holding the gas mixture 5. Breakdown of the gases located between the two arc-points 4 results in a highly-ionized plasma being formed between the two arc-points 4. In FIG. 2 there are a total of twelve arc-segments, six-by-six, located around the container 2 so that the arc-points 4 for each arc-segment extend through the container 2 and into the gas mixture 5. During the “firing” phase, all of the switches 2 of all the arc-segments are closed simultaneously causing all the energized capacitors 1 in each arc-segment to discharge across their respective arc-points 4. The gas mixture 5 located between each set of arc-points 4 is ionized as an arc forms between each set of arc-points 4 which forms a highly-conductive path of plasma between the arc-points 4. Notice, however, that the sets of arc-points 4 are arranged in a manner that results in overlapping electric current streams through the plasma and through the gas mixture 5. Because of that arrangement, a continuous, circular stream of plasma is formed inside the container 2 when the capacitors 1 in each arc-segment rapidly de-energize. As the capacitors 1 de-energize through the circular plasma-stream in the fuel/gas mixture of deuterium and tritium 5, a plasma-ring is formed and the intense electric current flowing in the plasma-ring will create a very strong magnetic field that will either produce an opposing magnetic field in the container 2 or else interact with an externally-produced magnetic field. Since the capacitors 1 had discharged across overlapping arc-points 4, the electric current in the plasma-ring will flow through a single continuous path of plasma that is formed between the arc-points 4 and through any remaining non-ionized gas mixture 5 (if that is possible!). In FIG. 3, the interaction of the magnetic field, B_{P}, generated by the large electric current, I_{P}, in the circular plasma stream, or plasma-ring, with the opposing immovable magnetic field, B_{C}, of the container is shown, results in the “pinching” of the plasma-ring. As the plasma-ring inside the container 2 is “pinched”, a higher level of compression (increase in pressure) causes a rapid rise in temperature and increased conductivity of the plasma which in turn raises the intensity of the electric current and associated magnetic field. The plasma is then compressed further by its own increased magnetic field as it continues to interact with the opposing magnetic field of the stationary inside-surface of the container 2. Now, since the plasma is contained in a closed ring, the plasma cannot expand along any single axis (as in the Z-pinch) so the compression and temperature of the plasma-ring continues to rise very rapidly. When the temperature of the plasma-ring inside the container 2 reaches a high enough temperature, the fusing of elements of the deuterium-tritium gas mixture will begin. As that happens, energy will be released to sustain a fusion reaction that is contained by the magnetic field of the outside container 2, which by the way, can be produced and sustained by the continuous electric current flowing in the plasma-ring of nuclear fuel. The C-pinch system works because of the arrangement of arc-points 4 in the container. Each capacitor 1 in each arc-segment acts independently when de-energizing across their respective arc-points 4; yet by doing so, the discharge of one capacitor 1 through the gas mixture 5 will aid the discharge of other capacitors 1. When a capacitor 1 de-energizes through the gas mixture 5, the path of least resistance will most likely be an already-ionized path created by the de-energizing of another capacitor 1. The capacitors 1 discharge across specific paths (arc-points) and they act independently when doing so. However, the capacitors 1 all discharge across their respective arc-points 4 in the same direction, such that one capacitor's discharge aids the discharge of one or two others. So, even though the capacitors 1 seem to act independently, there will be a single path for electric current to flow in the plasma-ring because there is a peculiar overlapping of electric current streams in the plasma-ring that is unique to this plasma-ring circuit.

Circuits simply cannot be found in nature where electric current is made to flow (without electromagnetic induction) where a power supply or battery is not connected in the series circuit and exhibiting an internal resistance! Moreover, in a normal dc series electric circuit, the amount of electric current flowing in the circuit is the same at all points in the circuit, but in the plasma-ring made by this generator, which is a simple dc circuit, there are points where the electric current can be as much as doubled when compared to an adjacent section that is not initially supplied by the de-energizing current from two capacitors. This phenomenon to be known as “current-noding” is evident in FIG. 2 by observing the overlapping of electric current streams resulting from the staggering of arc-points arranged in the configuration shown. The arrangement of capacitors, where they all discharge in the same direction through their respective arc-points located in the gas mixture to create an initial electric current stream in the plasma-ring, accomplishes the same task as inducing a current in the plasma-ring with an external magnetic field. And again, the most important thing to remember is that the plasma-ring cannot expand along any single axis when being compressed, so the pressure, temperature, and electric current inside the plasma-ring just keep increasing while segmentation or “breaking up” of the plasma is prevented!

Normally, a container made of any matter that can have a magnetic field induced by the electric current flowing in the plasma-ring can be used, as long as the induced magnetic field of the container opposes the magnetic field generated by the plasma-ring for compressing the plasma-ring to a high degree. For that matter, any container geometry, whether comprised of solid matter or some other structure of filaments or wires is possible. It is of course very possible to utilize a container comprised of superconducting electromagnets for achieving the purpose of compressing the plasma-ring. Using the superconducting electromagnets will obviously provide a containment means for the plasma-ring once the nuclear fusion reaction of the fuel/gas mixture occurs. In FIG. 3, a method for “supercharging” the plasma-ring generation process is shown. One or more coils of very fine tungsten wire 6 are wrapped around and placed on the inside of the container 2, and a separate supply of high-voltage power 7 is provided. As soon as the plasma-ring is formed inside the container by the multitude of capacitors arcing across their respective arc-points, a large electric current is applied to the tungsten coil 6 or coils (not shown). The tungsten wire coil 6 will “sacrificially” vaporize, thus “pinching” and emitting an intense burst of high-energy x-rays. The high-energy x-rays will then act on the plasma-ring forming inside the container 2 to heat and compress the plasma-ring in order to speed up and enhance the “pinching”-process of the plasma-ring. Possible candidate locations for wrapping the tungsten wires would be directly around the high or low current-density nodes that are evident in the plasma-ring and caused by “current-noding”. The supercharging process adds the effectiveness of an inertial confinement system (currently used in Z-machines) with the effectiveness of a C-pinch, plasma-ring that stays together and won't break up!

### Conclusion, Ramifications, and Scope

Accordingly, a C-pinch plasma-ring generator/reactor has been presented as the preferred embodiment of this invention which can be used for initiating, maintaining, and containing thermonuclear fusion reactions. Furthermore, it has been shown that the C-pinch concept by definition, is the “pinching” of a plasma-ring, or circular plasma-stream, with an inherent circulating electric current flowing in such a manner that its associated magnetic field interacts with another opposing magnetic field to highly-compress the plasma-ring for raising the temperature to a point where fusing of atoms or elements in the fuel/gas mixture comprising the plasma-ring will fuse together and release a tremendous quantity of energy in a sustained thermonuclear fusion reaction. The plasma-ring is formed by discharging high-voltage capacitors across arc-points arranged in a circular pattern inside a container that contains a mixture of gases, such as a half-and-half mixture of deuterium and tritium. Electric current is made to flow in the plasma-ring by the unique arrangement of arc-points that allow the capacitors to independently discharge in the same direction through the fuel/gas mixture while allowing the resulting electric current through the plasma to become additive and continuous. There are many advantages of using a C-pinch, plasma-ring generator to initialize, maintain, and contain a thermonuclear fusion reaction, but a few specific advantages are:
1. permitting electric power to be produced cheaply and cleanly;
2. making tremendous quantities of energy available for doing useful work;
3. lowering our dependency on foreign sources of fossil fuels;
4. providing an alternative to non-renewable energy sources; and
5. improving the national security of our country.

Although the description above contains much specificity, this should not be construed as limiting the scope of the invention, but as merely providing illustrations of the presently preferred embodiment of this invention. There are many conceivable embodiments of the present invention that can exploit the C-pinch concept as well as the creation of a plasma-ring with a circulating electric current. For example, it is conceivable to generate a plasma-ring in a C-pinch, plasma-ring generator for space propulsion. The plasma-ring can be generated in an electromagnetic cylinder and accelerated in one direction at a tremendous velocity. Since the plasma-ring has its own circulating electric-current and associated magnetic field, it can interact with, or react from, forces imposed on it by an external, stationary magnetic field, thus accelerating the detached rigid plasma-ring (with a “backbone”!) from the cylinder and out the rear of a spacecraft at a tremendous velocity! Multiple plasma-rings can also be made to interact together in a manner where the magnetic field of one acts upon the electric and magnetic fields of other plasma-rings in order to compress, accelerate, or heat one or more plasma-rings. Arc-points can be arranged in many different configurations inside a common container, so it is possible to have one or more plasma-rings surround, compress, and contain other plasma-rings as soon as they are generated. For that matter, in future generators and reactors of this type, no tungsten coil, wires, or filaments would be required to supercharge the process. Instead, the arc-points can be arranged so that several plasma-rings are formed around an inside plasma-ring where x-rays and the strong magnetic fields of several plasma-rings act together to bring the temperature of another plasma-ring, or more importantly, a fuel pellet, to critical temperatures hot enough for a fusion reaction to begin. It is also conceivable to use the ultrahigh magnetic field of one or more plasma-rings to concentrate ion-beams or any other magnetically-susceptible object. Arrangements of the arc-points in the C-pinch, plasma-ring generator are possible where a plasma-ring is not generated, but a toroidal or figure-eight plasma-structure with a circulating electric current is formed instead. It is conceivable that fuel for a nuclear fusion reaction that comprises the plasma-ring does not necessarily have to be deuterium or tritium, but the fuel can be in a solid or liquid state to begin with, and the specific matter used as nuclear fuel can vary from device-to-device and from application-to-application. In other words, any type of matter or physical element can be used as nuclear fuel, but the deuterium-tritium mixture seems to be the best candidate for use in the preferred embodiment of the present invention. “Current-noding” is a phenomenon worthy of further exploration and possible exploitation for a variety of uses. It is also conceivable to use a C-pinch, plasma-ring generator simply for the purpose of heating gases to extreme temperatures for use in heat engines without reaching temperature levels sufficient for achieving a fusion reaction of atoms in the gases. Finally, the C-pinch concept can be used to create conditions for producing soft and hard x-ray lasers. As the reader can see, there are many possible uses for other embodiments of the present invention. However, a reader skilled in the art will know that any device or method that exploits the C-pinch concept can, and will be, construed as an embodiment of the present invention. This will hold especially true for devices that are specifically designed to produce a plasma-ring or a plasma-structure by exploiting the C-pinch concept or by discharging a set of capacitors across their respective sets of arc-points that are arranged to form such plasma-rings, or plasma-structures with particular geometries. Thus, the scope of this invention should be determined by the appended claims and their legal equivalents, rather than by the examples given.

1-6. (canceled)

7. An apparatus for generating or creating closed-rings or continuous loops of plasma, comprising;
a) a multitude of arc-segments where each said arc-segment is comprised of a capacitor or any other power source and a set of two arc-points, and
b) a container comprised of any matter for rigidly holding and maintaining sufficient spacing between said multitude of sets of said arc-points arranged in a circular or any other closed-geometrical configuration, and
c) a gas, combination of gases, partial vacuum, or some other medium in said container located and filling the space between each set of said arc-points connected to each respective said power source or capacitor in each said respective arc-segment,
whereby said continuous loops, said plasma-rings, or said closed geometrical configurations of plasma can be created efficiently and effectively.

8. A method of generating or creating continuous loops, closed-rings, or closed geometrical configurations of plasma, comprising:
a) providing an apparatus for generating or creating continuous loops, closed-rings, or closed geometrical configurations of plasma, comprised of a multitude of arc-segments where each said arc-segment is comprised of a capacitor and a set of two arc-points, and where said apparatus is also comprised of a container for rigidly holding and maintaining spacing between a multitude of sets of said arc-points arranged in a circular or any other closed-geometrical configuration and a gas, combination of gases, vacuum, or some other medium in said container located and filling the space between each set of said arc-points connected to each respective said capacitor in each said respective arc-segment then,
b) energizing each said capacitor in each said arc-segment to a do voltage not sufficient to cause arcing between said arc-points in each said arc-segment then,
c) applying a higher dc voltage to at least one said capacitor in at least one said arc-segment where said higher dc voltage is sufficient to cause arcing between said arc-points in said arc-segments ten,
d) allowing a progression of arcing to occur between all overlapping said arc-points arranged in said circular or any other said closed geometrical configuration beginning with at least one said capacitor in said arc-segment energized to a higher dc voltage sufficient to cause arcing between said arc-points then,
e) forming said continuous loop, said closed-ring, or said closed geometrical configuration of plasma between all sets of overlapping said arc-points as each said capacitor in each said arc-segment de-energizes across each set of said arc-points in each said arc-segment in one electrical direction through said gas, said vacuum, or said other medium present between each set of said arc-points, whereby said continuous loops, said closed-rings, or said closed geometrical configurations of plasma are formed efficiently and effectively.

9. An apparatus for generating or creating closed-rings or continuous loops of plasma, comprising a multitude of sets of electrodes where each said set of electrodes is comprised of both a positively-energized and a negatively-energized electrode with respect electrically to each other, and where each said set of electrodes is held rigidly in a container comprised of any matter and energized by a separate power source so that a complete said closed-ring, said continuous loop, or a closed geometrical configuration of plasma can be created when each said set of oppositely and electrically energized electrodes arc de-energized one to the other electrically in order to provide an electric current for ionizing and electrically breaking down a gas, combination of gases, or partial vacuum contained in said container, whereby said continuous loops or closed-rings of plasma can be created efficiently and effectively.
